(19) United States
(12) Patent Application Publication
(10) Pub. No.: US 2008/0208805 A1
(43) Pub. Date: Aug. 28, 2008

(54) APPARATUS AND METHOD FOR REMOTE QUERYING OF DATA SOURCES

(75) Inventors: Yuru Wang, Coquitlam (CA); Huan Wu, Burnaby (CA); Ju Wu, Coquitlam (CA)

Correspondence Address: COOLEY GODWARD KRONISH LLP;ATTN: Patent Group, Suite 1100, 777 - 6th Street, NW, Washington, DC, 20001, US

(73) Assignee: BUSINESS OBJECTS, S.A., Levallois-Perret (FR)

(21) Appl. No.: 11/680,553

(22) Filed: Feb. 28, 2007

(51) Int. Cl. G06F 17/30

(52) U.S. Cl. 707/3; 707/E17.032

(57) ABSTRACT

A computer readable storage medium includes executable instructions to receive a report document at a report query engine. The report document includes a definition of a report. The report document is processed to extract a remote location for a data source driver for the report. A request for the data for the report is transmitted via a consumer across a communication channel to the remote location. The data is received. A report instance is created from the data. The report instance includes the data processed in accordance with the definition of the report.

### BRIEF DESCRIPTION OF THE INVENTION

This invention relates generally to database access techniques. More particularly, this invention relates to techniques for querying remote data sources.

### BACKGROUND OF THE INVENTION

Business Intelligence (BI) generally refers to software tools used to improve business enterprise decision-making. These tools are commonly applied to financial, human resource, marketing, sales, customer and supplier analyses. More specifically, these tools can include: reporting and analysis tools to present information, content delivery infrastructure systems for delivery and management of reports and analytics and, and data warehousing systems for cleansing and consolidating information from disparate sources. Business Intelligence tools work with data management systems, such as relational databases or On Line Analytic Processing (OLAP) systems used to collect, store, and manage raw data.

A subset of business intelligence tools are reporting tools. There are a number of commercially available products to produce reports from stored data. For instance, Business Objects Americas of San Jose, Calif., sells a number of widely used report generation products, including Crystal Reports™, Business Objects OLAP Intelligence™, Business Objects Web Intelligence™, and Business Objects Enterprise™. As used herein, the term report refers to information automatically retrieved (i.e., in response to computer executable instructions) from a data source (e.g., a database, a data warehouse, a plurality of reports, and the like), where the information is structured in accordance with a report schema that specifies the form in which the information should be presented. A non-report is an electronic document that is constructed without the automatic retrieval of information from a data source. Examples of non-report electronic documents include typical business application documents, such as a word processor document, a presentation document, and the like.

A report document specifies how to access data and format it. A report document where the content does not include external data, either saved within the report or accessed live, is a template document for a report rather than a report document. Unlike, other non-report documents that may optionally import external data within a document, a report document by design is primarily a medium for accessing and, formatting, transforming and or presenting external data.

A report is specifically designed to facilitate working with external data sources. In addition to information regarding external data source connection drivers, the report may specify advanced filtering of data, information for combining data from different external data sources, information for updating join structures and relationships in report data, and instructions including logic to support a more complex internal data model (that may include additional constraints, relationships, and metadata).

In contrast to a spreadsheet type application, a report generation tool is generally not limited to a table structure but can support a range of structures, such as sections, cross-tables, synchronized tables, sub-reports, hybrid charts, and the like. A report design tool is designed primarily to support imported external data, whereas a spreadsheet application equally facilitates manually entered data and imported data. In both cases, a spreadsheet application applies a spatial logic that is based on the table cell layout within the spreadsheet in order to interpret data and perform calculations on the data. In contrast, a report design tool is not limited to logic that is based on the display of the data, but rather can interpret the data and perform calculations based on the original (or a redefined) data structure and meaning of the imported data. The report may also interpret the data and perform calculations based on pre-existing relationships between elements of imported data. Spreadsheets applications generally work within a looping calculation model, whereas a report generation tools may support a range of calculation models. Although there may be an overlap in the function of a spreadsheet document and a report document, the applications used to generate these documents contain instructions with express different assumptions concerning the existence of an external data source and different logical approaches to interpreting and manipulating imported data.

There is a need to enhance BI software to facilitate reporting based on remote data sources. Currently, BI tools accessing remote data sources may not have the required data source drivers and adapters. Data sharing with a reporting tool is particularly useful in peer-to-peer and Software-as-a-Service (SaaS) frameworks. In these frameworks firewalls and network security create boundaries between the BI tool and the remote data sources.

In view of the foregoing, it would be advantageous to provide enhancements to BI tools that facilitate accessing remote data sources. In addition, it would be desirable to enhance BI tools, such as report viewers, to support data source drivers to access data sources.

Distributed computing techniques define computer-to-computer interactions in the way that the HyperText Markup Language (HTML) and Hyper Text Transport Protocol (HTTP) do for people-to-computers interaction. Some of these techniques provide a common object model optionally augmented with a naming or a security model. Other services can be layered atop these core services.

A common object model makes data access over a network easier. The model includes the provision of techniques for making information about the data available to other systems. The information can include the data type, data location, connection information, and supplementary actions that may be performed on the data. The model allows a sender to point to a variable, object, piece of data, and the like, and simply send it. The object then appears in the address space of the destination. The serializing, transporting, and unserializing of the transmission is hidden from sender and receiver.

There are network communication techniques that add metadata to data requested over a network. The addition of metadata can be used to preserve aspects of the data that would normally be lost once the data is ported. Normally, the structure of the data at its source is lost. However, the logical interrelationship of the requested data is preserved and transmitted. This allows the requester to use the requested data as if the data were in the source system.

Web Services (WS) are a class of protocols for distributed computing and network communication that provide a common object model, make information about the data available to other systems and add metadata to the data requested, WS include an XML base that facilitates interoperability among implementations, A web service has an interface that is specified in a format such as the Web Service Description Language (WSDL). Other systems interact with the web service in a manner prescribed by the interface using messages, which may be enclosed in a container, such as SOAP (also known as Simple Object Access Protocol), which is a protocol for exchanging extensible Markup Language (XML) messages over a computer network. SOAP forms the foundation layer of the web service stack, providing a basic messaging framework that more abstract layers can build on.

It would be desirable to create distributed BI tools. In particular, it would be desirable to expand reporting tools with techniques to perform remote data access.

### SUMMARY OF INVENTION

The invention includes a computer readable storage medium with executable instructions to receive a report document at a report query engine. The report document includes a definition of a report. The report document is processed to extract a remote location for a data source driver for the report. A request for the data for the report is transmitted via a consumer across a communication channel to the remote location. The data is received. A report instance is created from the data. The report instance includes the data processed in accordance with the definition of the report.

The invention also includes a computer readable storage medium with executable instructions to define a data source driver configured to access a data source. An adapter coupled to the data source driver is defined. The adapter makes calls to an interface of the data source driver. A provider is disposed between the adapter and a communication channel. The provider includes executable instructions to receive a request for data from a remote consumer, pass the request to the adapter, and make a query to the data source through the adapter and data source driver.

The invention also includes a computer system with a report processing server including a consumer and a report engine that processes a report document. While processing the report document, the report engine makes a call to the consumer to access data remote to the report processing server. A data server includes a provider configured to receive calls from the consumer and a data source driver coupled to the provider via a data server adapter. A communication channel couples the report processing server to the data server. Data is requested from the data server by the consumer. The request is processed by the provider. The provider obtains the data via the data source driver. The data is returned to the report engine via the consumer. The report engine creates an instance of the report document with the data.

### BRIEF DESCRIPTION OF THE FIGURES

The invention is more fully appreciated in connection with the following detailed description taken in conjunction with the accompanying drawings, in which:

FIG. 1 illustrates a system including two coupled computers in accordance with an embodiment of the invention.

FIG. 2 illustrates a remote report system in accordance with an embodiment of the invention.

FIG. 3 illustrates a set of high level processing operations for creating a report associated with an embodiment of the invention.

FIG. 4 illustrates a set of low level processing operations associated with accessing data on a remote computer associated with an embodiment of the invention.

FIG. 5 illustrates a set processing operations associated with processing a request at a remote computer associated with an embodiment of the invention.

FIG. 6 illustrates another remote report system including a first computer that queries a data source on a second computer in accordance with an embodiment of the invention.

FIG. 7 illustrates a set of low level processing operations associated with accessing data on a remote computer associated with an embodiment of the invention.

FIG. 8 illustrates a system including two computers each of which can make remote data queries to the other computer in accordance with an embodiment of the invention.

Like reference numerals refer to corresponding parts throughout the several views of the drawings.

### DETAILED DESCRIPTION OF THE INVENTION

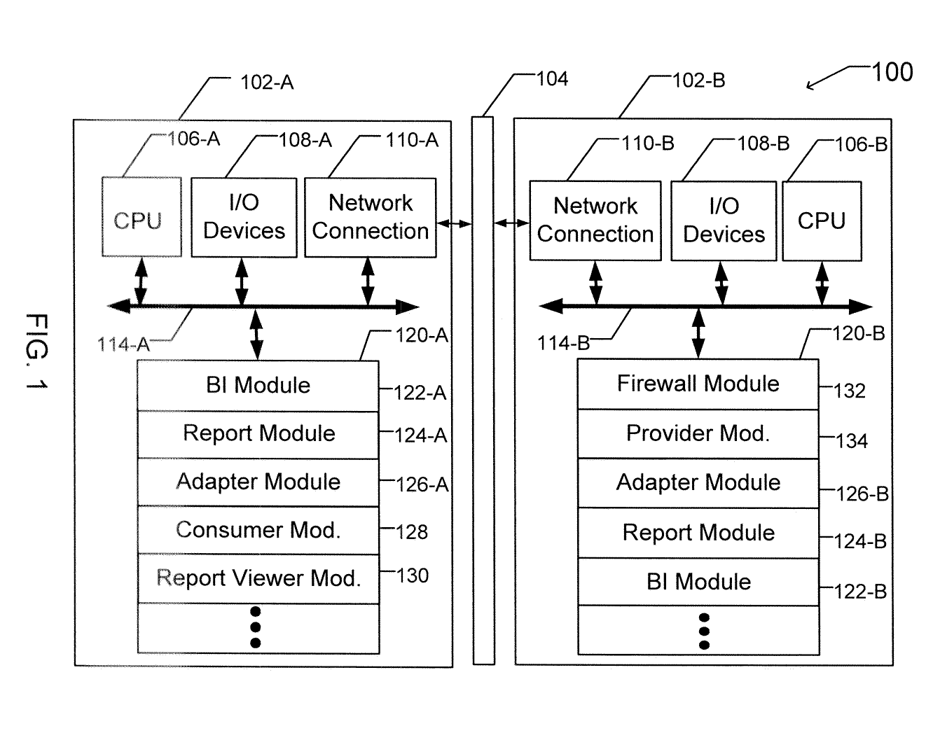

FIG. 1 illustrates a system 100 configured in accordance with an embodiment of the invention. The system 100 includes two or more coupled computers, e.g., arranged in a peer-to-peer architecture. The system 100 includes a first computer 102-A and a second computer 102-B. A data signal can be sent from the first computer to the second computer and vice versa via communication channel 104, which may be any wired or wireless channel.

Each computer 102 includes a central processing unit 106 connected to a set of input/output devices 100 and a network connection circuit 110 via a bus 114. As shown in FIG. 1, computer 102-A includes a CPU 106-A input/output devices 108-A, a network connection circuit 110-A and a bus 114-A, while computer 102-B includes a CPU 106-B, input/output devices 108-B, a network connection circuit 110-B and a bus 114-B. For the purpose of simplicity, individual components, e.g., 106-A and 106-B, are collectively referenced only by their number, e.g., 106. The input/output devices 108 may include standard components, such as a keyboard, mouse, display, printer, and the like. The network connection circuit 110 provides connectivity to communication channel 104.

Also connected to the bus 114 is a memory 120. The memory 120 stores executable instructions to implement operations of the invention. In an embodiment, the memory 120 stores one or more of the following modules: BI module 122, a report module 124, an adapter module 126, a consumer module 128, report viewer module 130, a firewall module 132, and a provider module 134. In an embodiment, computer 102-A includes the report module 122, the adapter module 126, and the consumer module 128. In an embodiment, computer 102-B includes the firewall module 132, the provider module 134, and adapter module 126. In another embodiment, computers 102-A and 102-B have the same modules.

The BI module 122 includes executable instructions to perform BI related functions on computers 102-A or 102-B, across system 100 or a wider network. BI related functions include: gathering, integrating, analyzing data, reporting data, and the like. The BI module 122 includes instructions to implement authentication at the application and data level and the scheduling of BI jobs—including reporting jobs. The BI module 122 is optional for both computers.

The report module 124 includes instructions for generating reports, viewing a report, performing query and analysis, and the like. The report module 124 includes executable instructions to access a data source (not shown). In an embodiment, the data source is selected from a data warehouse, a plurality of reports, text files and the like. In another embodiment, the data source is a database: relational, OLAP, or other. The report module 214 includes instructions to access data locally or remotely. Local data access occurs when instructions from the report module 124 interact with local data source drivers. Remote data access involves interaction with data source drivers on another computer, in an embodiment, report module 124 includes instructions to define a report query engine and a report print engine which collectively define a report engine. As used herein a report engine is either or both of a report query engine and a report print engine.

The adapter module 126 includes instructions to provide a wrapper to a subsystem including modules, classes or entities. The adapter module provides a single point of entry for the subsystem. The adapter module 126 exposes an API to the report module 124 and other modules.

The consumer module 128 includes executable instructions to communicate with the provider module 134. The consumer module 128 provides instructions to consume data sent from a provider. This data can be structured and include metadata—e.g., Really Simple Syndication (RSS) and XML added to data to state its structure or add other metadata. In an embodiment, the consumer module 128 includes executable instructions to consume a Web Service (WS) provided by a WS provider. In this embodiment, the consumer module 128 implements WS consumption and provides an interface for calls to a WS provider. The executable instructions in the report module 124 access a WS consumer defined by WS consumer module 126. In an embodiment, the WS consumer module implements a data source driver and calls to a WS consumer are made as if it were a specific database driver. The WS consumer module 128 allows the report module 124 to access a remote data provider.

The report viewer module 130 includes executable instruction to display a report document to a user. The report viewer can be part of a report engine or a stand alone component for viewing a report document. Report documents can be local to the viewer or sent to the viewer by a remote content server—e.g., the viewer is a thin client.

The optional firewall module 132 includes executable instructions to enforce a boundary between two or more computers on a network. The firewall module includes instructions to monitor all traffic in or out of a computer, permitting only traffic which is authorized to pass. The firewall can be hardware, software or a combination of hardware and software components.

The provider 134 includes executable instructions to provide data to the consumer module 128. The data can be provided as an RSS feed, a data feed with XML added to data to state its structure or provide other metadata, a web service or the like. In an embodiment, the provider 134 includes executable instructions to provide a web service. The provider module 134 provides information like tables, fields, links and the link for a data source. The provider module includes instructions to receive a request for data from a WS consumer and pass the request to instructions that will build a query, execute the query and retrieve the data. The provider module 134 includes instructions to configure a WS provider to run on a public internet protocol IP address and optionally set up security controls on access.

The modules stored in memory 120 are exemplary. Additional modules such as an operating system or GUI module can be included. It should be appreciated that the functions of the presented modules may be combined. In addition, a function of a module need not be performed on a single machine, e.g., the first computer or the second computer. Instead, the function may be distributed across system 100 or a wider network, if desired. In an embodiment of the present invention, the system 100 may operate in a client-server architecture rather than a peer-to-peer architecture.

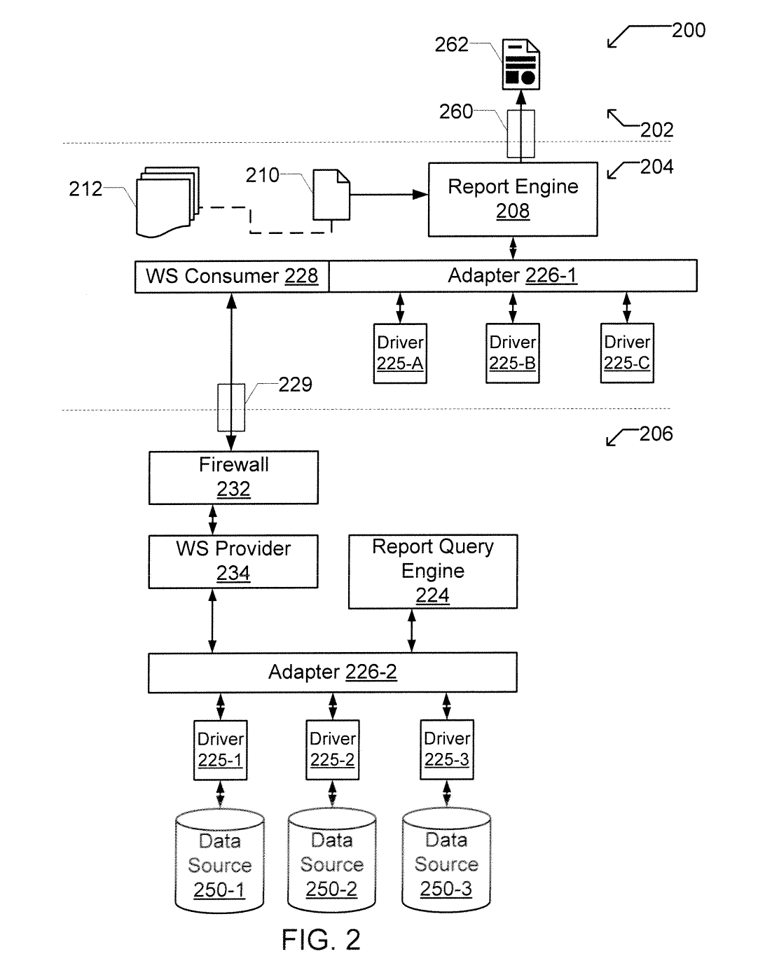

FIG. 2 illustrates the interrelationship and interactions between software components defined in computers 102-A and 102-B. These components and their interactions define a remote reporting system 200. The system 200 includes a client region 202, a server region 204 and a data server region 206. The client region 202 is where a report is viewed. The server region 204 includes a report engine 208 that processes a report document 210. The report document 210 can be a report template or report instance both of which contain a definition for the report. This definition can include a set of properties 212. The set of properties 212 includes properties for the data server region including location, server type, logon credentials, and the like. In an embodiment, the client region 202 and the server region 204 can be combined on one system to create a peer-to-peer system with the data server region 206. The data server region 206 includes the data source drivers for the data source for the report.

The report document 210 is processed by the report engine 208. The report engine 208 is coupled to a series of optional data source drivers 225-A, 225-B, 225-C via an adapter 226-1. The adapter 226-1 is defined by instructions in the adapter module 126. A specific implementation of the adapter 226-1 is a WS consumer 228. The WS consumer 228 implements the interface of the adapter, but instead of providing functions to access the data source behind the data source drivers 225-A, 225-B, 225-C, the consumer makes calls to a remote data source. The WS consumer 228 receives requests for data from the report engine 208. The WS consumer 228 uses information in ache properties 212 to locate and communicate with a provider of a web service across a network. In an embodiment, the property is a universal resource locator (URL). The remote reporting system 200 includes a communication channel 229 any wired or wireless channel. The WS consumer 228 acts as a proxy. The WS consumer 228 makes calls, such as function calls, to a WS provider.

The data server region 206 of system 200 includes an optional firewall 232. The firewall 232 fronts a WS provider 234. The WS provider 234 is coupled to an adapter 226-2. The adapter 226-2 is part of a normal BI or report installation. The adapter 226-2 communicates with one or more data source drivers 225 in the same manner as a report query engine 224 included in the data server region 206. Each data source driver 225-1, 225-2 and 225-3 is used to access a coupled data source 250-1, 250-2 and 250-3. In an embodiment, a data source driver is coupled to two or more data sources.

The WS consumer 228 makes calls to the WS provider 234. The calls include logon, query, and the like. The WS consumer 228 mimics functions that the WS provider 234 exposes. In this way calls made to the WS consumer 228 are passed through the channel 229 to the WS provider 234. With respect to function calls, the WS consumer 228 exists in a one-to-one relationship with the WS provider 234. The relationship is one-to-one because each call to the WS consumer 228 is matched by a call to the WS provider 234 and a call to the adapter 226-2. The WS provider 234 makes some unmatched calls to the adapter. These calls include instruction calls to the adapter to load a library, release memory, and the like.

The data is retrieved from one ore more data sources and passed back up through the WS provider 234, via the channel 229 to the server region 204. The data is processed by the report engine 208 to create a report instance 260. The report instance 260 is sent via another wired or wireless communication channel 262 to the client region 202. The report instance is processed and displayed by a report viewer defined by instructions in the report viewer module 130.

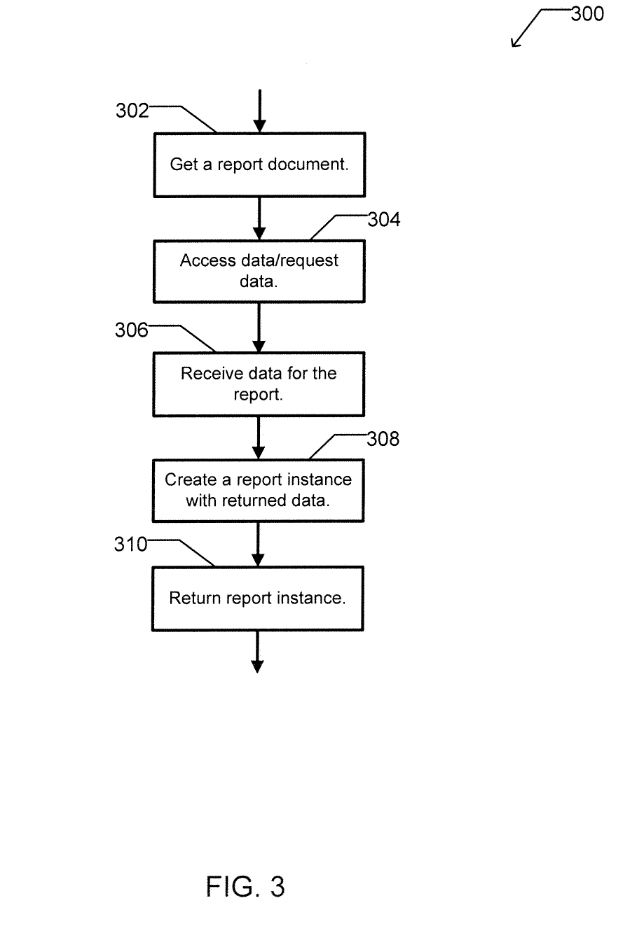

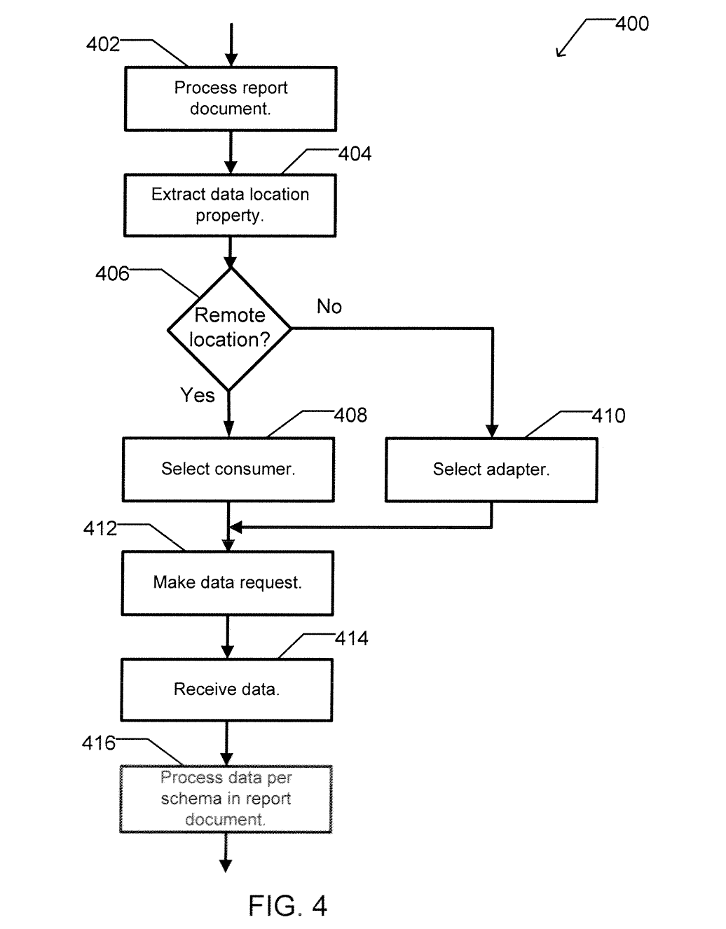

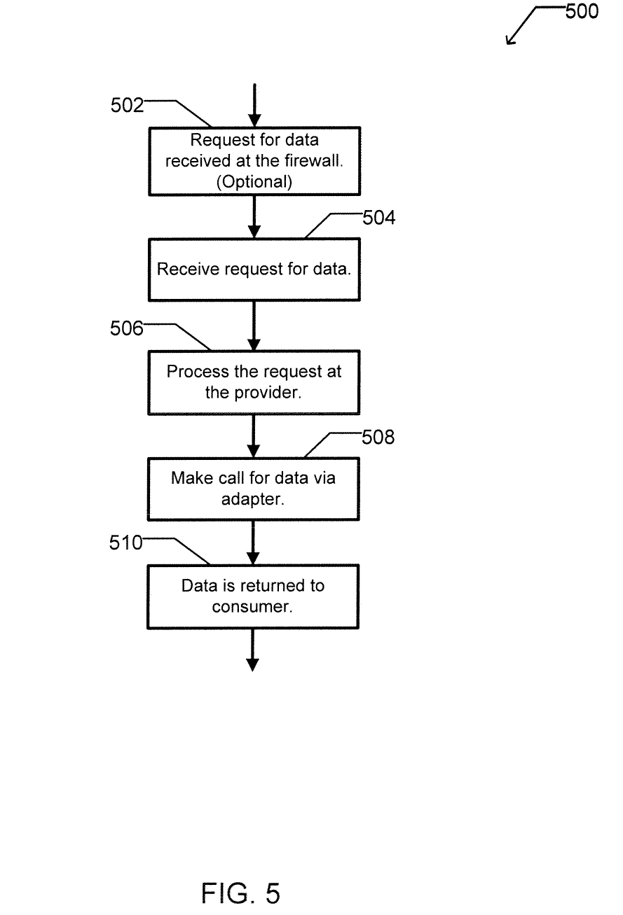

FIG. 3 illustrates a high level workflow associated with an embodiment of the invention. Initially, a report document is retrieved 302. The report document may be a report with a definition and saved data or a report template without saved data. The report document may include properties that define the location of the data source. Using the location property, data for the report is requested 304. This data request includes a query passed by the report engine through the WS consumer. The data is accessed in accordance with processing operations such as those illustrated in FIGS. 4 and 5. The data is received 306. A report is created 308. The data is processed and formatted per the definition of the report. The processing and formatting may include the application of filters and formulas, formatting per a template, and the like. The completed report is returned 310.

FIG. 4 illustrates a set of processing operations 400 associated with an embodiment of the invention. The operations 400 are implemented principally by a report engine to create a report using remote data access techniques. A report document is processed 402. A location property storing the location of a data source is extracted from within the report document 404. The report engine determines if the data source named by the location property is remote to the report engine 406. If 406-Yes, a consumer (e.g., the WS consumer 228 of FIG. 2) is selected to be called by the report engine 408. If 406-No, the data source is local and the adapter is selected to perform a local data source access 410. The data for the report is requested 412. If the consumer has been selected, the request sent to the data source is via the consumer 412. The data is returned and received 414. In an embodiment, the data request is returned in a synchronous manner. In an embodiment, the data request is returned asynchronously and the processing continues while other requests are made. The data is processed according to the schema in the report document 416. The data can be filtered or have formulas applied to it. The filters can be defined by the report's schema or view time settings. The data is formatted per the report definition. The data can be combined with additional data. That is, combined with more data from the same data source or another data source such as, a different remote data source, a local data source, or saved data within the report document, and the like.

FIG. 5 illustrates a set processing operations associated with processing a request at a remote computer associated with an embodiment of the invention. The data request is processed by the firewall 502. The firewall determines if the request is to be passed to the WS provider. In an embodiment, the firewall is a reverse proxy that routes only valid requests to the WS provider. A valid request is one which is properly formatted, from a known source, not from a black listed source, and the like. The data server receives a request for data for a report at the WS provider 504. The WS provider processes the request for data 506. The processing includes selecting a specific adapter. In an embodiment, the request includes constructing a query defined in the request against a data source. The processing also includes checking the logon credentials provided by the consumer. The processing may further include resolving which data source driver should be accessed via the adapter. The WS provider makes a call for the data via the adapter 508. The data is returned to the WS consumer via the WS provider, 510.

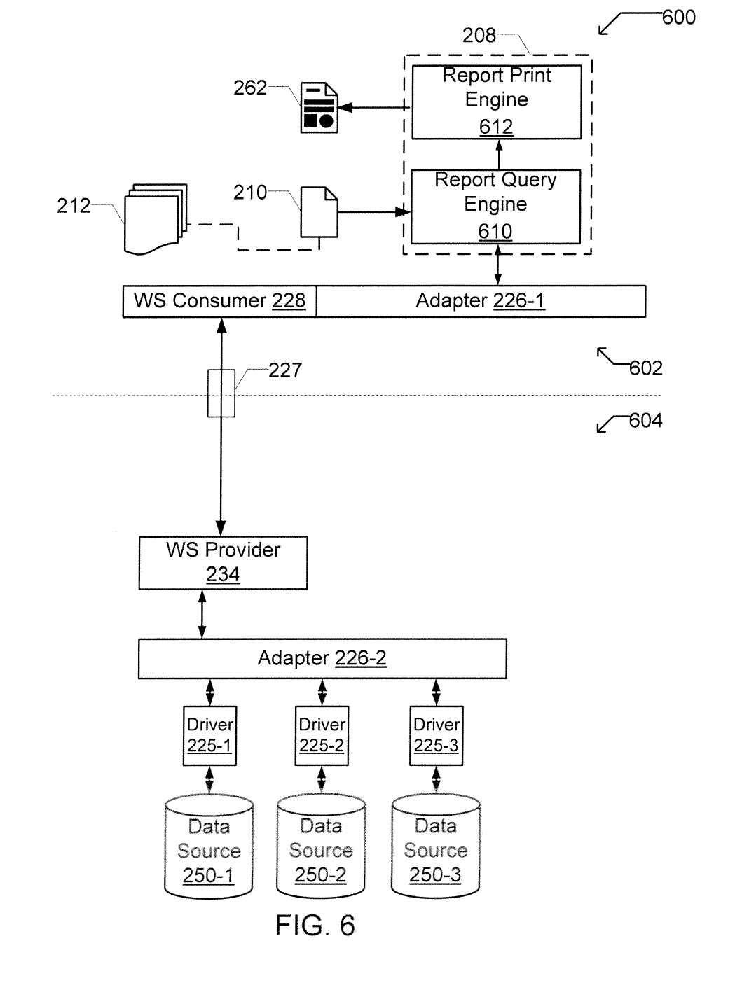

FIG. 6 illustrates a remote reporting system similar to the one shown in FIG. 2. The remote reporting system 600 is configured in accordance with an embodiment of the invention. As with FIG. 2, the components of FIG. 6 are defined by the executable instructions in computers 102-A and 102-B of FIG. 1. Remote reporting system 600 and remote reporting system 200 share many common elements. The system 600 includes a client region 602 and a server region 604. The client region 602 is where a report is created and viewed. Client region 602 differs from server region 204 in FIG. 2 in two ways. One, the report instance is viewed within client region 602. Two, client region 602 lacks any data source drivers. The server region 604 is where the data for the report is retrieved. Server region 604 differs from data server region 206 in FIG. 2 in two ways. One, there is no firewall in server region 604. Two, there is no report engine in server region 604.

The communication between remote regions in FIG. 6 can adhere to known protocols and operate with additional security. The WS communication between consumer 228 and provider 234 is prescribed by a Web Service Description Language (WSDL). WSDL makes it possible to describe an endpoint for a WS message and its behavior. WSDL layers additional information over the XML schema definitions that describe the actual WS messages. Hence WSDL provides meta-information about, for instance, a data source to be accessed. Security can be provided by encryption on the communication channel 227. Further security can be provided at the report document and data source levels. Still further security can be provided by calls to the BI module, which handles security at the level of task, user, user group and the like.

The report document 210 is processed by the report query engine 610 within the report engine 208. The report engine 208 is coupled to an adapter 226-1. However, the data source drivers optional in FIG. 2 are omitted. The WS consumer 228 implements the interface of the adapter 226-1 and makes calls to the WS provider 234. The data is retrieved from a data source in or coupled to region 604. The data is processed by the report query engine 610 and the report print engine 612. The report instance 262 is viewed within the client region 602.

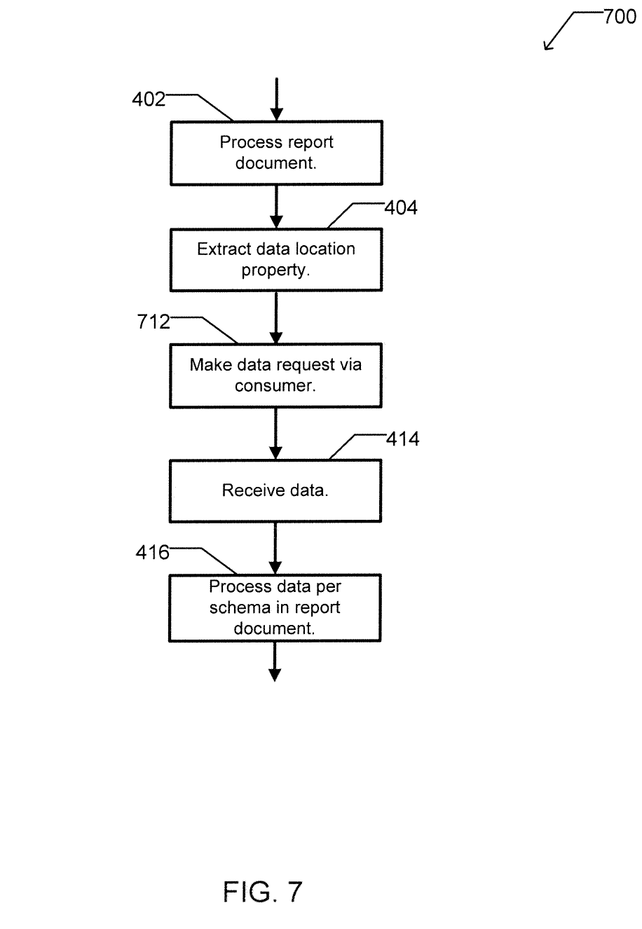

FIG. 7 illustrates a set of processing operations 700 associated with the remote reporting system 600 of FIG. 6. The operations 700 are implemented principally by a report engine to create a report using remote data access techniques in accordance with an embodiment of the invention, A report document is processed 402. A location property within the document is located 404. Since there are no data source drivers in client region 602, the location is assumed to be remote. The data for the report is requested via the consumer 712. The data is returned and received 414. The data is processed according to the schema in the report document or view time settings 416.

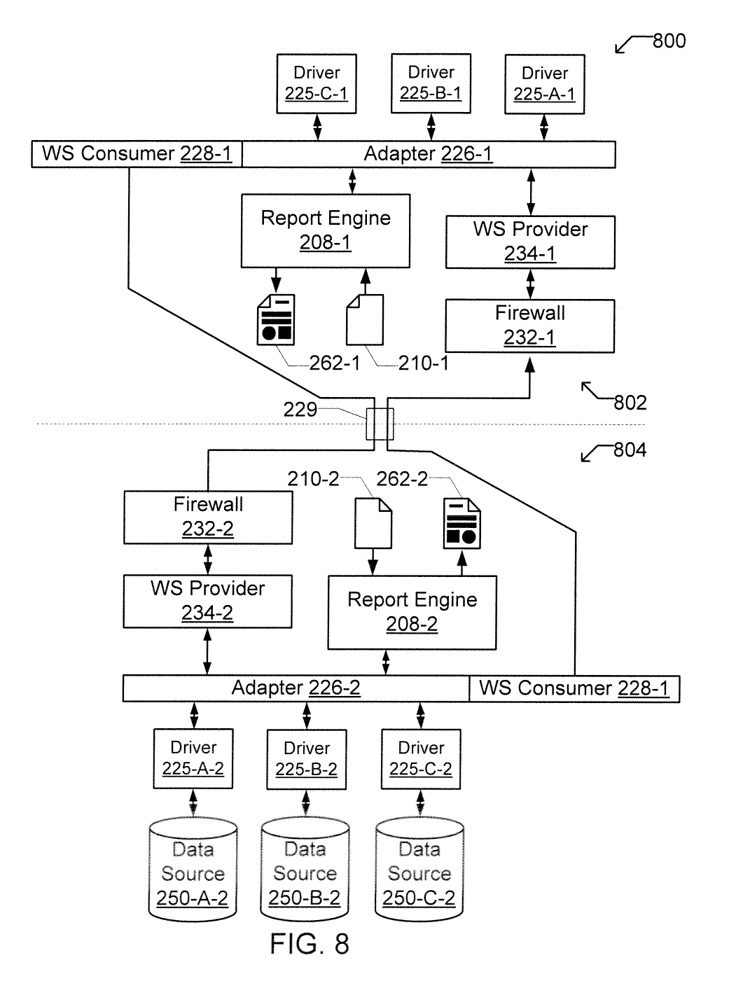

FIG. 8 illustrates a system including two computers each of which can make remote data queries of the other in accordance with an embodiment of the invention. The remote reporting system 800 is configured in accordance with an embodiment of the invention. As with FIGS. 2 and 6, the components of FIG. 8 are defined by the executable instructions in computers 102-A and 102-B of FIG. 1. Remote reporting system 800 includes two equivalent regions 802 and 804. For the purpose of simplicity, individual components, e.g., 208-1 and 208-2, are collectively referenced only by their number, e.g., 208.

Each region in the remote reporting system 800 has a report engine 208, a series of data source drivers 225, and an adapter 226. Each region has at least one data source. For region 804 the data sources are 250-A-2, 250-B-2 and 250-C-2. For region 802 the data sources are not shown. Each region has a WS consumer 228, firewall 232, and WS provider 234. Report documents 210 are processed in one region with data requested from the other region. The data requests (e.g., queries) and data are sent between the WS consumers 228 and WS providers 234 through the communication channel 229.

In an embodiment, the WS consumer 228 is a specific implementation of the adapter 226. The WS consumer 228 relays requests to the adapter behind its corresponding WS provider 234. These requests include which data source driver to use and the information contained within the data source property within the report document. The WS consumer 228 performs various operations on the request depending on the embodiment of the invention. These operations may include the following. The consumer 228:

receives the request from the report engine 208;

converts the request for transmission across the communication channel 229;

converts the request to a format required by WS provider 234;

receives the data from the WS provider 234;

stores data to create a local data cache within region 802;

transforms the data to the required format; and

returns the data to the report engine 208.

The WS provider 234 performs various operations on the request depending on the embodiment of the invention. These operations may include the following. The WS provider 234:

receives the request from the WS consumer 228;

initializes the adapter 226;

determines the syntax of that the adapter 226 requires;

passes the request to the adapter 226;

receives the data from the data source via the adapter 226;

transforms the data to the required format; and

returns the data to the WS consumer 228.

In an embodiment, the WS consumer implements the interface of a data source driver. The report engine calls the adapter with a data source query defined by a report. The adapter makes calls to the WS consumer as if it were a data source driver. The WS consumer then relays the calls to the WS provider. The processing continues through the adapter and data source drivers local to the WS provider. This remote adapter includes state variables to know which data source driver and data source it is interacting with. The interaction between the consumer and provider includes an extra overhead of calls to establish which data source driver to use.

Apparatus and methods for remote reporting have been presented in the preceding figures. Some of these figures, i.e., FIGS. 1, 2, 6, 8, show a remote report system. In these systems any enterprise with a BI or reporting tool can share data with, or consume data from, another enterprise. The data provider can make the data available to their potential consumers. These consumers access the data using a modified version of a reporting tool. In some embodiments, the modification comprises the inclusion of a consumer. A provider is also included in the system with the data source drivers. In an embodiment, the provider's system also includes a reporting tool.

Aspects of the remote reporting system include on-line report creation, refreshing, and scheduling. Additionally, the disclosed systems provide a framework for any BI system to share data with other BI systems and/or consume other BI system's data. This is illustrated in FIG. 8. These aspects of the invention make the invention suitable for use in a software as a service framework.

Herein, when introducing elements of embodiments of the invention the articles “a”, “an”, “the” and “said” are intended to means that there are one or more of the elements. The teams “comprising”, “including” and “having” are intended to be inclusive and to mean that there may be additional elements other than the listed elements.

An embodiment of the present invention relates to a computer storage product with a computer-readable medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs, DVDs and holographic devices; magneto-optical media; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. A computer readable storage medium, comprising executable instructions to:
receive a report document at a report query engine, wherein the report document includes a definition of a report;
process the report document to extract a remote location for a data source driver for the report;
transmit a request for the data for the report via a consumer and across a communication channel to the remote location;
receive the data; and
create a report instance from the data, wherein the report instance includes the data processed in accordance with the definition of the report.

2. The computer readable storage medium of claim 1 wherein the consumer:
implements the same interface as an adapter to access data sources, and
overwrites a local data source access function with a remote data source access function.

3. The computer readable storage medium of claim 2 wherein the consumer is the consumer of a Web Service (WS).

4. The computer readable storage medium of claim 3 further comprising executable instructions to implement communication from the consumer to the remote location according to a protocol defined in a Web Services Description Language (WSDL) file.

5. The computer readable storage medium of claim 1 wherein the report instance is processed by the application of one or more operations selected from: formatting the data; applying a formula to the data; filtering of the data; combining the data with additional data; applying a join operation to the data, and inserting logic to support a more complex data model, and adding metadata to the data.

6. The computer readable storage medium of claim 1 further comprising executable instructions to initialize the consumer in place of an adapter to access data sources.

7. The computer readable storage medium of claim 1 wherein the remote location of the data source is stored as a universal resource locator (URL).

8. The computer readable storage medium of claim 1 wherein the executable instructions to include executable instructions to send a query to a data source.

9. The computer readable storage medium of claim 8 further comprising executable instructions to transmit a request for the data across a communication channel.

10. The computer readable storage medium of claim 1 further comprising executable instructions to define a local data source driver coupled to an adapter.

11. The computer readable storage medium of claim 1 further comprising one or more executable instructions selected from:
executable instructions to return the report instance,
executable instructions to display the report instance, and
executable instructions to transmit the report instance across a communication channel.

12. A computer readable storage medium, comprising executable instructions to:
define a data source driver configured to access a data source;
define an adapter coupled to the data source driver, wherein the adapter makes calls to an interface of the data source driver; and
define a provider disposed between the adapter and a communication channel. wherein the provider includes executable instructions to:
receive a request or data from a remote consumer,
pass the request to the adapter, and
make a query to the data source through the adapter and data source driver.

13. The computer readable storage medium of claim 12 wherein the request is based on a report definition.

14. The computer readable storage medium of claim 13 wherein the request is a query to the data source.

15. The computer readable storage medium of claim 12 further comprising executable instructions to return the data to the remote consumer.

16. The computer readable storage medium of claim 12 further comprising executable instructions to define a report query engine, wherein both the report query engine and the provider make calls to the data source via the adapter and the data source driver.

17. The computer readable storage medium of claim 12 further comprising executable instructions to facilitate interaction between the provider and the remote consumer through a firewall disposed between the provider and the communication channel, wherein the firewall filters for calls received from the remote consumer.

18. The computer readable storage medium of claim 12 wherein the provider is a web service (WS) provider and the consumer is a WS consumer.

19. A computer system, comprising:
a report processing server including a consumer and a report engine that processes a report document, wherein while processing the report document the report engine makes a call to the consumer to access data remote to the report processing server;
a data server, including a provider configured to receive calls from the consumer and a data source driver coupled to the provider via a data server adapter; and
a communication channel coupling the report processing server to the data server;
wherein:
data is requested from the data server by the consumer,
the request is processed by the provider,
the provider obtains the data via the data source driver,
the data is returned to the report engine via the consumer, and
the report engine creates an instance of the report document with the data.

20. The computer system of claim 19 further comprising a client for viewing a report created by the report processing server with data retrieved from the data server.

21. The computer system of claim 19 wherein the communication between the consumer and the provider is via Web Services (WS).

22. The computer system of claim 19 wherein the consumer implements the interface of a server adapter used by a report engine to access local data source drivers.
